(19) United States
(12) Patent Application Publication
(10) Pub. No.: US 2014/0110868 A1
(43) Pub. Date: Apr. 24, 2014

(54) METHOD OF MANUFACTURING DISPLAY DEVICE

(71) Applicants: SAMSUNG DISPLAY CO., LTD., Yongin-City (KR); PUSAN NATIONAL UNIV. INDUSTRY-UNIVERSITY COOPERATI, Busan (KR)

(72) Inventors: Soon Joon RHO, Suwon-si (KR); Hyunggeun YOON, Hwaseong-si (KR); Hyelim JANG, Yongin-si (KR); Hyeokjin LEE, Seongnam-si (KR); Jung Wook KIM, Busan (KR); Dong Han SONG, Busan (KR); Tae Hoon YOON, Busan (KR)

(73) Assignees: Pusan National Univ. Industry-University Cooperati, Busan (KR); Samsung Display Co., Ltd., Yongin-City (KR)

(21) Appl. No.: 13/855,159

(22) Filed: Apr. 2, 2013

(30) Foreign Application Priority Data
Oct. 23, 2012 (KR) 10-2012-0118021

(51) Int. Cl. G02F 1/1337; B29D 11/00

(52) U.S. Cl. CPC G02F 1/13378; B29D 11/0073
USPC 264/1.38; 264/1.36

(57) ABSTRACT

A method for forming a display device includes forming a liquid crystal layer between a first substrate and a second substrate spaced apart from the first substrate, in which the liquid crystal layer includes a liquid crystal composition including a reactive mesogen, applying an electric field to the liquid crystal layer, firstly curing the liquid crystal layer at a temperature from about −20° C. to about 60° C., and secondly curing the liquid crystal layer without applying the electric field. The liquid crystal composition includes the reactive mesogen in an amount exceeding 0 percent by weight and equal to or smaller than about 30 percent by weight relative to a total weight of the liquid crystal composition.

### CROSS-REFERENCE TO RELATED APPLICATION

This application claims priority to Korean Patent Application No. 10-2012-0118021, filed on October 23, 2012, the disclosure of which is hereby incorporated by reference herein in its entirety.

### TECHNICAL FIELD

The present disclosure relates to a method of manufacturing a display device to effectively pre-tilt liquid crystal molecules.

### DISCUSSION OF THE RELATED ART

A liquid crystal display device may be classified into, for example, one of a twisted nematic liquid crystal display device, a horizontal alignment liquid crystal display device, and a vertical alignment electric field liquid crystal display device.

In the vertical alignment liquid crystal display device, a long axis of liquid crystal molecules is aligned vertically to a substrate while no electric field is applied to the vertical alignment liquid crystal display device. Accordingly, a viewing angle is wide and a contrast ratio is high.

Various methods, e.g., a rubbing method, a light-aligning method, etc., are widely used to align the liquid crystal molecules in a desired direction. As the light-aligning method for the vertical alignment liquid crystal display device, a method of aligning the liquid crystal molecules using a reactive mesogen has been suggested.

### SUMMARY

Exemplary embodiments of present invention provide a method of manufacturing a display device to effectively pre-tilt liquid crystal molecules.

Embodiments of the present invention provide a method for forming a display device which includes forming a liquid crystal layer between a first substrate and a second substrate spaced apart from the first substrate, in which the liquid crystal layer includes a liquid crystal composition including a reactive mesogen, applying an electric field to the liquid crystal layer, firstly curing the liquid crystal layer at a temperature from about −20° C. to about 60° C., and secondly curing the liquid crystal layer without applying the electric field.

The liquid crystal composition includes the reactive mesogen in an amount exceeding 0 percent by weight and equal to or smaller than about 30 percent by weight relative to a total weight of the liquid crystal composition.

The liquid crystal composition includes the reactive mesogen in the amount exceeding 0 percent by weight and equal to or smaller than about 0.5 percent by weight relative to the total weight of the liquid crystal composition and the first curing is performed at the temperature from about −20° C. to about 20° C.

An ultraviolet ray is further applied to the liquid crystal layer during the first curing process, and the ultraviolet ray is substantially simultaneously performed with the applying of the electric field.

The second curing is performed using a heat or an ultraviolet ray.

The method further includes forming a pixel electrode on the first substrate and forming a common electrode on the second substrate, and the electric field is formed between the pixel electrode and the common electrode. The pixel electrode includes a trunk portion and a plurality of branch portions protruded and extended from the trunk portion.

In accordance with an exemplary embodiment of the present invention, a method for forming a display device is provided. The method includes forming a pixel electrode on a first base substrate,
forming a first main alignment layer on the first base substrate on which the pixel electrode is formed,
forming a common electrode on a second base substrate disposed opposite to the first base substrate,
forming a second main alignment layer on the second base substrate on which the common electrode is formed, forming a liquid crystal layer between the first and second main alignment layers, and in which the liquid crystal layer comprises a liquid crystal composition including a reactive mesogen.

The method further includes applying an electric field to the liquid crystal layer, firstly curing the reactive mesogen of the liquid crystal layer at a temperature from about −20° C. to about 60° C. while the electric field is being applied to the liquid crystal layer and secondly curing the reactive mesogen of the liquid crystal layer without applying the electric field to the liquid crystal layer, thereby forming a first reactive mesogen layer disposed on the first main alignment layer and a second reactive mesogen layer disposed on the second main alignment layer. The liquid crystal composition comprises the reactive mesogen in an amount exceeding 0 percent by weight and equal to or smaller than about 30 percent by weight relative to a total weight of the liquid crystal composition.

In accordance with an exemplary embodiment of the present invention, a method for forming a display device is provided. The method includes forming a first initial alignment layer on a first base substrate, in which the first initial alignment layer is a polymer layer including a first reactive mesogen, forming a second initial alignment layer on a second base substrate disposed opposite to the first base substrate, in which the second initial alignment layer includes a second reactive mesogen, and forming a liquid crystal layer between the first initial alignment layer and the second initial alignment layer, in which the liquid crystal layer comprises a liquid crystal composition which does not include a reactive mesogen.

In addition, the method further includes applying an electric field to the first and second initial alignment layers, firstly curing the first and second initial alignment layers at a temperature from about −20° C. to about 60° C. while the electric field is being applied to the first and second initial alignment layers and secondly curing the first and second initial alignment layers without applying the electric field to the first and second initial alignment layers, thereby forming a first reactive mesogen layer on the first base substrate and a second reactive mesogen layer on the second base substrate.

According to the above exemplary embodiments, the black display of a display device may be increased and the falling time may be remarkably shortened.

### BRIEF DESCRIPTION OF THE DRAWINGS

Exemplary embodiments of the present invention can be understood in more detail from the following detailed description taken in conjunction with the accompanying drawings wherein:

FIG. 1 is a plan view showing a portion of a liquid crystal display device according to an exemplary embodiment of the present invention;

FIG. 2 is a cross-sectional view taken along a line I-I′ shown in FIG. 1;

FIG. 3 is a flowchart showing a method of manufacturing the liquid crystal display device according to an exemplary embodiment of the present invention;

FIGS. 4A and 4B are cross-sectional views showing a method of aligning an alignment layer according to an exemplary embodiment of the present invention;

FIG. 5 is a graph showing a transmittance as a function of a first curing temperature of a reactive mesogen and an applied voltage in the liquid crystal display device according to an exemplary embodiment of the present invention;

FIG. 6 is a graph showing a falling time according to a concentration of the reactive mesogen and a first curing temperature of a reactive mesogen;

FIG. 7 is a graph showing a relative value of a black level according to the concentration of the reactive mesogen and a first curing temperature of a reactive mesogen;

FIG. 8 is a graph showing the relative value of the black level according to a first curing temperature; and

FIG. 9 is a flowchart showing a method of manufacturing the liquid crystal display device according to another exemplary embodiment of the present invention.

### DETAILED DESCRIPTION OF EXEMPLARY EMBODIMENTS

It will be understood that when an element or layer is referred to as being “on”, “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be explained in detail with reference to the accompanying drawings.

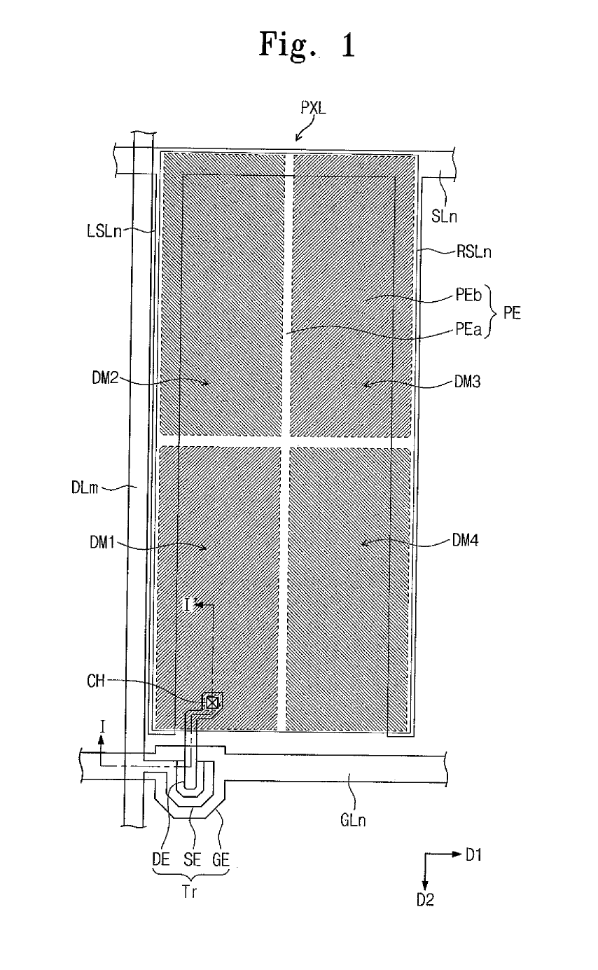

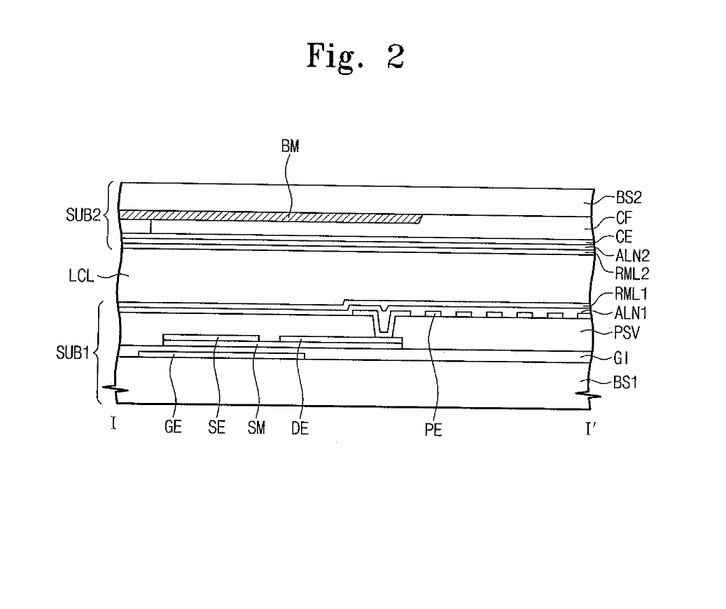

FIG. 1 is a plan view showing a portion of a liquid crystal display device according to an exemplary embodiment of the present invention and FIG. 2 is a cross-sectional view taken along a line shown in FIG. 1. In the present exemplary embodiment, pixels have the same configuration and function, and thus for the convenience of explanation, only one pixel has been shown with a gate line and a data line, which are adjacent to the one pixel.

Referring to FIGS. 1 and 2, the liquid crystal display device includes, for example, a first substrate SUB1, a second substrate SUB2 facing the first substrate SUB1, and a liquid crystal layer LCL disposed between the first substrate SUB1 and the second substrate SUB2.

The first substrate SUB1 includes, for example, a first base substrate BS1, a plurality of gate lines, a plurality of data lines, a plurality of pixels PXL, a first main alignment layer ALN1, and a first reactive mesogen layer RML1. The first base substrate BS1 has, for example, a rectangular shape and is formed of a transparent insulating material. For example, in an exemplary embodiment the first base substrate BS1 may include transparent glass, quartz, plastic, or the like. Also, in an exemplary embodiment, the first base substrate BS1, may be formed of, for example, ceramic or silicon materials. Further, in an exemplary embodiment, the first base substrate BS1 may be, for example, a flexible substrate. Suitable materials for the flexible substrate include, for example, polyethersulfone (PES), polyethylenenaphthalate (PEN), polyethylene (PE), polyimide (PI), polyvinyl chloride (PVC), polyethylene terephthalate (PET), or combinations thereof.

For the convenience of explanation, one pixel has been shown in FIGS. 1 and 2 together with an n-th gate line GLn among the gate lines and an m-th data line DLm among the data lines. In the present exemplary embodiment, however, the other pixels have the same configuration and function, and thus the n-th gate line GLn and the m-th data line DLm will be referred to as a data line and a gate line, respectively.

The gate line GLn is disposed on the first base substrate BS1 and extended in a first direction D1. The data line DLm is extended in a second direction D2 crossing the first direction D1 and a gate insulating layer GI is disposed between the gate line GLn and the data line DLm. The gate insulating layer GI is disposed over substantially the entire surface of the first base substrate BS1 to cover the gate line GLn. Alternatively, in an exemplary embodiment, the data line DLm is extended in the first direction D1 and the gate line GLn is extended in the second direction D2 crossing the first direction D1.

The gate insulating layer GI may be made of, for example, silicon nitride (SiNx), silicon oxide (SiOx), silicon oxynitride (SiOxNy), aluminum oxide (AlOx), yttrium oxide (Y₂O₃), hafnium oxide (HfOx), zirconium oxide (ZrOx), aluminum nitride (AlN), aluminum oxynitride (AlNO), titanium oxide (TiOx), barium titanate (BaTiO3) , lead titanate (PbTiO₃), or a combination thereof. Each pixel PXL is connected to the corresponding gate line GLn of the gate lines and the corresponding data line DLm of the data lines. Each pixel PXL includes, for example, a thin film transistor Tr, a pixel electrode PE connected to the thin film transistor Tr, and a storage electrode part. The thin film transistor Tr includes, for example, a gate electrode GE, the gate insulating layer GI, a semiconductor pattern SM, a source electrode SE, and a drain electrode DE. The storage electrode part includes, for example, a storage line SLn extended in the first direction D1 and first and second branch electrodes LSLn and RSLn branched from the storage line SLn and extended in the second direction D2.

The gate electrode GE is, for example, protruded from the gate line GLn or formed on a portion of the gate line GLn.

The gate electrode GE includes, for example, a metal material. The gate electrode GE may be formed of, for example, nickel, chromium, molybdenum, aluminum, titanium, copper, tungsten, gold, palladium, platinum, neodymium, zinc, cobalt, manganese and any mixtures or an alloy thereof. The gate electrode GE has a single-layer structure or a multi-layer structure. For instance, the gate electrode GE has a triple-layer structure of molybdenum, aluminum, and molybdenum, which are sequentially stacked one on another, or a double-layer structure of titanium and copper, which are sequentially stacked.

The semiconductor pattern SM is disposed on the gate insulating layer GI. The semiconductor pattern SM is disposed on the gate electrode GE with the gate insulating layer GI interposed therebetween. The semiconductor pattern SM is partially overlapped with the gate electrode GE. The semiconductor pattern SM may include, for example, an active pattern (not shown) disposed on the gate insulating layer GI and an ohmic contact layer (not shown) disposed on the active pattern. The active pattern may include, for example, an amorphous silicon thin layer and the ohmic contact layer may include an n+ amorphous silicon layer. The ohmic contact layer allows the source and drain electrodes SE and DE to ohmic contact with the active pattern.

The source electrode SE is branched from the data line DLm. The source electrode SE is disposed on the ohmic contact layer and partially overlapped with the gate electrode GE.

The drain electrode DE is, for example, spaced apart from the source electrode SE while interposing the semiconductor pattern SM therebetween when viewed in a plan view. The drain electrode DE is disposed on, for example, the ohmic contact layer and partially overlapped with the gate electrode GE.

The source electrode SE and the drain electrode DE may be formed of, for example, nickel, chromium, molybdenum, aluminum, titanium, copper, tungsten, gold, palladium, platinum, neodymium, zinc, cobalt, manganese and any mixtures or an alloy thereof. The source electrode SE and the drain electrode DE have a single-layer structure or a multi-layer structure of the above-mentioned metal materials. For instance, the source electrode SE and the drain electrode DE have a double-layer structure of titanium and copper, which are sequentially stacked, or a single-layer structure of the alloy of titanium and copper.

Accordingly, the upper surface of the active pattern is exposed through, for example, between the source electrode SE and the drain electrode DE, and the active pattern serves as a channel part, e.g., a conductive channel, between the source electrode SE and the drain electrode DE. The source electrode SE and the drain electrode DE are, for example, overlapped with the semiconductor pattern SM. The pixel electrode PE is connected to the drain electrode DE with a protective layer PSV interposed therebetween. The pixel electrode PE is partially overlapped with the storage line SLn and first and second branch electrodes LSLn and RSLn to form a storage capacitor.

The protective layer PSV covers the source electrode SE, the drain electrode DE, the channel part, and the gate insulating layer GI and is provided with a contact hole CH formed through to expose a portion of the drain electrode DE. The protective layer PSV may include, for example, silicon nitride or silicon oxide.

The pixel electrode PE is connected to the drain electrode DE through the contact hole CH formed through the protective layer PSV.

The pixel electrode PE includes, for example, a trunk portion PEa and a plurality of branch portions PEb extended from the trunk portion in a radial form. The trunk portion PEa or a part of the branch portions PEb is connected to the drain electrode DE through the contact hole CH.

The trunk portion PEa may have various shapes. As an example, the trunk portion PEa has a cross shape as shown in FIG. 1. In this case, the pixel PXL is divided into, for example, plural domains by the trunk portion PEa and the branch portions PEb are extended in different directions according to the domains. In the present exemplary embodiment, as an example, the pixel PXL includes a first domain DM1, a second domain DM2, a third domain DM3, and a fourth domain DM4. The branch portions PEb are extended, for example, substantially in parallel to each other and spaced apart from each other in each domain

The branch portions PEb, which are adjacent to each other, are spaced apart from each other in terms of micrometers. This is to align liquid crystal molecules of the liquid crystal layer LCL to a specific azimuth on a plane parallel to the first base substrate BS1.

The pixel electrode PE is formed of, for example, a transparent conductive material. For example, the pixel electrode PE is formed of a transparent conductive oxide such as, e.g., indium tin oxide (ITO), indium zinc oxide (IZO), indium tin zinc oxide (ITZO), aluminum doped zinc oxide (AZO), and cadmium tin oxide (CTO), or a reflective electric conductor such as, for example, aluminum (Al), gold (Au), silver (Ag), copper (Cu), iron (Fe), titanium (Ti), tantalum (Ta), molybdenum (Mo), rubidium (Rb), tungsten (W), and alloys, or combinations thereof. In addition, the pixel electrode PE can be formed of, for example, transflective materials or a combination of transparent materials and reflective materials.

The first main alignment layer ALN1 is disposed on the protective layer PSV to cover the pixel electrode PE. The first reactive mesogen layer RML1 is disposed on the first main alignment layer ALN1.

The first main alignment layer ALN1 and the first reactive mesogen layer RML1 include, for example, a plurality of areas aligned corresponding to the first to fourth domains DM1 to DM4. For example, in the present exemplary embodiment, the first main alignment layer ALN1 and the first reactive mesogen layer RML1 include first to fourth areas, and the liquid crystal molecules are aligned in different directions in the first to fourth domains DM1 to DM4 respectively corresponding to the first to fourth areas.

The second substrate SUB2 includes, for example, a second base substrate BS2, and a color filter CF, a black matrix BM, a common electrode CE, a second main alignment layer ALN2, and a second reactive mesogen layer RML2 are disposed on the second base substrate BS2. For example, in an exemplary embodiment, the second base substrate BS2 may include the same material as the first base substrate BS1.

The color filter CF is disposed on, for example, the second base substrate BS2 and assigns a color to the light passing through the liquid crystal layer LCL. In the present exemplary embodiment, the color filter CF is disposed on the second substrate SUB2, but exemplary embodiments of the present invention are not limited thereto or thereby. That is, for example, the color filter CF may alternatively be disposed on the first substrate SUB1 rather than the second substrate SUB2 according to embodiments.

The black matrix BM is disposed to correspond to a light blocking area of the first substrate SUB1. The light blocking area is the area in which the data line DLm, the thin film transistor Tr, and the gate line GLn are disposed. As the pixel electrode PE is not formed in the light blocking area, the liquid crystal molecules are not aligned and a light leakage occurs in the light blocking area. Thus, the black matrix BM is disposed in the light blocking area to prevent the occurrence of the light leakage in the light blocking area.

The common electrode CE is disposed on the color filter CF and forms an electric field in cooperation with the pixel electrode PE to drive the liquid crystal layer LCL. The common electrode CE is formed of, for example, a transparent conductive material. For example, the common electrode CE is formed of a conductive metal oxide, such as indium tin oxide (ITO), indium zinc oxide (IZO), indium tin zinc oxide (ITZO), aluminum doped zinc oxide (AZO) or cadmium tin oxide (CTO), etc.

The second main alignment layer ALN2 is disposed on the common electrode layer CE. The second reactive mesogen layer RML2 is disposed on the second main alignment layer ALN2. For example, the second main alignment layer ALN2 and the second reactive mesogen layer RML2 are the same as the first main alignment layer ALN1 and the first reactive mesogen layer RML1 except that the second main alignment layer ALN2 and the second reactive mesogen layer RML2 are disposed on the second substrate SUB2. Thus, detailed descriptions of the second main alignment layer ALN2 and the second reactive mesogen layer RML2 will be omitted to avoid redundancy.

The liquid crystal layer LCL including the liquid crystal molecules is disposed between the first substrate SUB1 and the second substrate SUB2. The liquid crystal layer LCL has a negative dielectric anisotropy, but exemplary embodiments of the present invention are not limited thereto or thereby. That is, for example, the liquid crystal layer LCL may alternatively have a positive dielectric anisotropy.

In the liquid crystal display device, when a gate signal is applied to the gate line GLn, the thin film transistor Tr is turned on. Accordingly, a data signal applied to the data line DLm is applied to the pixel electrode PE through the turned-on thin film transistor Tr. When the data signal is applied to the pixel electrode PE through the turned-on thin film transistor Tr, the electric field is generated between the pixel electrode PE and the common electrode CE. The liquid crystal molecules are driven by the electric field generated by a difference between voltages respectively applied to the common electrode CE and the pixel electrode PE. Therefore, the amount of the light passing through the liquid crystal layer LCL is changed, and thus a desired image is displayed.

Meanwhile, the liquid crystal display device according to the present exemplary embodiment of the present invention may have various shapes. For instance, one pixel may be connected to two gate lines and one data line or to one gate line and two data lines according to embodiments. In addition, one pixel may have, for example, two sub-pixels applied with different voltages from each other. In this case, one of the two sub-pixels is applied with a high voltage and the other one of the two sub-pixels is applied with a low voltage.

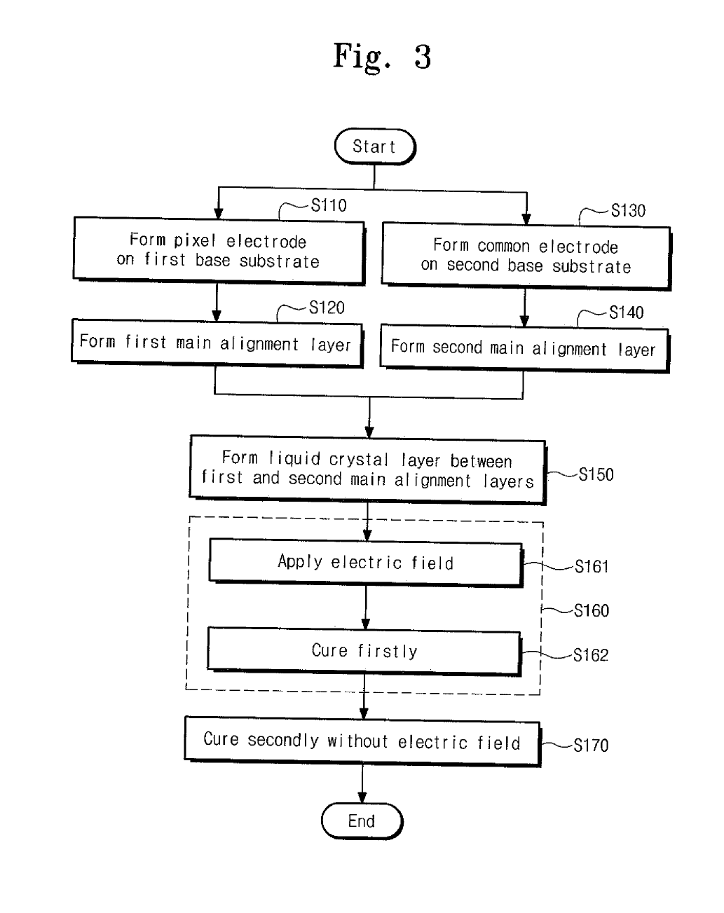

FIG. 3 is a flowchart showing a method of manufacturing the liquid crystal display device according to an exemplary embodiment of the present inventive.

For example, referring to FIG. 3, to manufacture the liquid crystal display device, the pixel electrode PE is formed on the first base substrate BS1 (S110) and the first main alignment layer ALN1 is formed on the first base substrate BS1 (S120). The common electrode CE is formed on the second base substrate BS2 (S130), and the second main alignment layer ANL2 is formed on the second base substrate BS2 (S140). Then, the liquid crystal layer LCL is disposed between the first main alignment layer ALN1 and the second main alignment layer ALN2 (S150). The liquid crystal layer LCL includes, for example, a reactive mesogen RM. After that, while the electric field is applied to the liquid crystal layer LCL (S161), the reactive mesogen RM of the liquid crystal layer LCL is firstly cured (S162)(S160). Then, the electric field disappears and the reactive mesogen RM of the liquid crystal layer LCL is secondly cured (S170), thereby forming the first and second reactive mesogen layers RML1 and RML2.

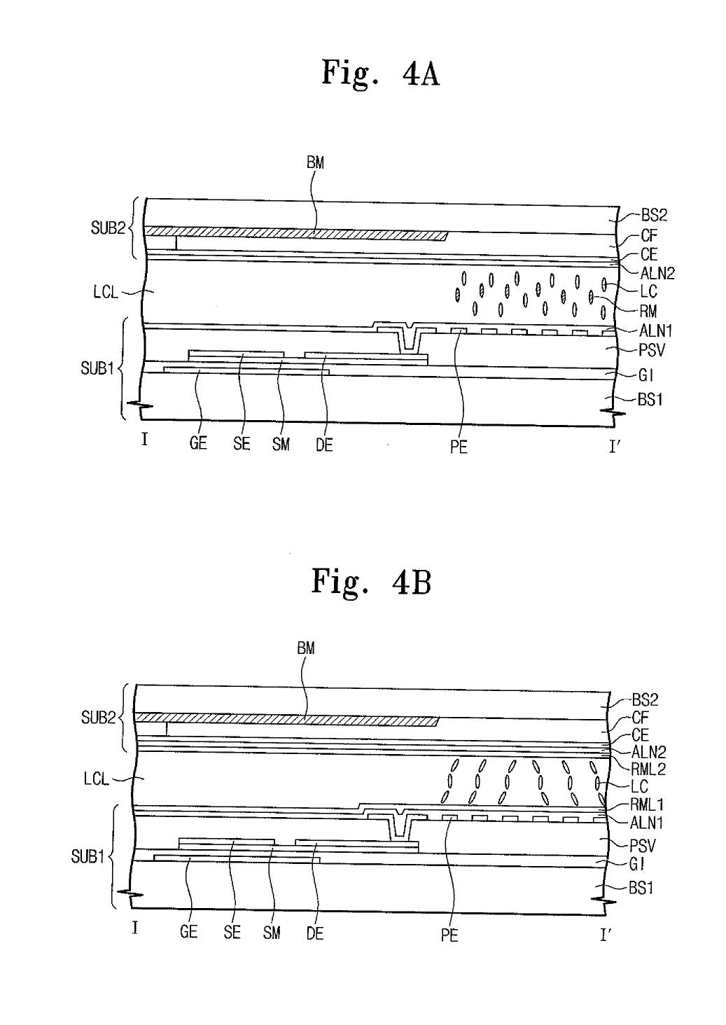

FIGS. 4A and 4B are cross-sectional views showing a method of aligning an alignment layer according to an exemplary embodiment of the present invention.

Hereinafter, for example, the method of manufacturing the liquid crystal display device will be described in detail with reference to FIGS. 1 to 3, 4A, and 4B.

The method of manufacturing the first base substrate BS1 will be described with reference to FIGS. 1 and 2.

A gate pattern is formed on the first base substrate BS1. The gate pattern includes the gate line GLn and the storage electrode part. The gate pattern may be formed by, for example, a photolithography process.

The gate insulating layer GI is formed on the gate pattern.

The semiconductor pattern SM is formed on the gate insulating layer GI. The semiconductor pattern SM includes, for example, the active pattern and the ohmic contact layer disposed on the active pattern. The semiconductor pattern SM may be formed by, for example, a photolithography process.

A data pattern is formed on the semiconductor pattern SM. The data pattern includes, for example, the data line DLm, the source electrode SE, and the drain electrode DE. The data pattern may be formed by, for example, a photolithography process. In this case, the semiconductor pattern SM and the data pattern are formed using, for example, one half mask or one diffraction mask.

The protective layer PSV is formed on the data pattern. The protective pattern PSV includes, for example, the contact hole CH formed therethrough to expose the portion of the drain electrode DE and may be formed by a photolithography process.

The pixel electrode PE is formed on the protective layer PSV and connected to the drain electrode DE through the contact hole CH. The pixel electrode PE may be formed by, for example, a photolithography process.

Then, the first main alignment layer ALN1 is formed on the first base substrate SUB1 on which the pixel electrode PE is formed. The first main alignment layer ALN1 is formed by, for example, coating a polymer, e.g., polyimide, or an alignment solution including a monomer of polymer on the first base substrate BS1 and heating the alignment solution.

Referring to back FIGS. 1 and 2, the color filter CF that displays the color is formed on the second base substrate BS2. The common electrode CE is formed on the color filter CF. The color filter CF and the common electrode CE may be formed by, for example, a photolithography process.

The second main alignment layer ALN2 is formed on the second base substrate BS2 on which the common electrode CE is formed. Although not shown in figures, the second main alignment layer ALN2 is formed by, for example, coating a second alignment solution on the second substrate SUB2 and heating the second alignment solution. The second main alignment layer ALN2 includes, for example, the same component as the first main alignment layer ALN1 and is formed by the same process used to form the first main alignment layer ALN1.

Then, the first substrate SUB1 and the second substrate SUB2 are disposed to face each other and the liquid crystal layer LCL is formed between the first substrate SUB1 and the second substrate SUB2.

The liquid crystal layer LCL includes, for example, a liquid crystal composition containing the reactive mesogen RM. The reactive mesogen RM indicates light-curable particles, e.g., photo-crosslinkable low or high molecular weight copolymer and causes a chemical reaction, e.g., a polymerization reaction, when a ray with specific wavelength, such as an ultraviolet ray, is applied thereto. For instance, the reactive mesogen RM may include acrylate, methacrylate, epoxy, oxetane, vinyl-ether, styrene, or a thiolene group. The reactive mesogen RM may be a material having, for example, a bar shape structure, a banana shape structure, a board shape structure, or a disc shape structure.

In the present exemplary embodiment, the reactive mesogen RM may be a compound represented by, for example, the following chemical formula 1

R₁—P-Q-R₂ Chemical formula 1

In chemical formula 1, each of P and Q individually represents

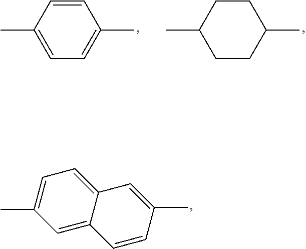

or a single bond except that P and Q are simultaneously single bond. Hydrogen atoms of P and Q are substituted by F, Cl, alkyl group having a number of carbons in the range of 1 to 12, or —OCH₃, and each of R₁ and R₂ individually represents

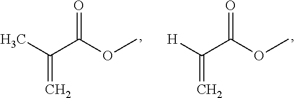

or hydrogen atoms except that R₁ and R₂ are simultaneously single bond.

The reactive mesogen RM may be included in an amount exceeding 0 percent by weight and equal to or smaller than about 30 percent by weight relative to the total weight of the liquid crystal composition. In addition, in the present exemplary embodiment, the reactive mesogen RM may be included in an amount exceeding 0 percent by weight and equal to or smaller than about 3 percent by weight relative to the total weight of the liquid crystal composition.

Then, referring to FIG. 4B, the electric field is applied to the liquid crystal layer LCL. In addition, the ultraviolet ray is applied to the liquid crystal layer LCL while the electric field is applied to the liquid crystal layer LCL so as to firstly cure the reactive mesogen RM included in the liquid crystal layer LCL.

When a predetermined time lapses after the ultraviolet ray is applied to the liquid crystal layer LCL, the first reactive mesogen layer RML1 is formed on the first base substrate BS1 and the second reactive mesogen RML2 is formed on the second base substrate BS2. For example, the first reactive mesogen layer RML1 is formed on the first main alignment layer ALN1 and the second reactive mesogen layer RML2 is formed on the second main alignment layer ALN2. The first and second reactive mesogen layers RML1 and RML2 pretilt the liquid crystal molecules LC.

For example, when the electric field is applied to the liquid crystal molecules LC, the reactive mesogens RM are aligned in the same direction as the liquid crystal molecules LC in the area surrounding the reactive mesogens RM. When the ultraviolet ray is provided to the liquid crystal layer LCL while the reactive mesogens RM are aligned in the same direction as the liquid crystal molecules LC, the reactive mesogens RM are polymerization-reacted with each other, and thus a network is formed between the reactive mesogens RM. The reactive mesogens RM are linked to adjacent reactive mesogens RM to form a side chain. In this case, as the reactive mesogens RM form the network after the liquid crystal molecules LC are aligned, the reactive mesogens RM have a specific directivity according to an average alignment direction of the liquid crystal molecules LC. Thus, although the electric field disappears, the liquid crystal molecules LC disposed adjacent to the network have a pretilt angle.

In the first curing process, a temperature of the liquid crystal layer is maintained in a range, for example, from about −20° C. to about 60° C. In this case, the temperature of the first curing process is varied depending on the concentration of the reactive mesogen RM.

Then, the firstly-cured reactive mesogen RM is secondly cured after the electric field disappears. In the present exemplary embodiment, the second curing process is performed by, for example, irradiating at least one of heat and ultraviolet ray to the reactive mesogen RM. The second curing process may be performed at a temperature different from that of the first curing process, or performed at the same temperature as that of the first curing process according to embodiments. In the second curing process, for example, the ultraviolet ray is applied to the reactive mesogen RM, so that the reactive mesogen RM, which is not cured in the first curing process, may be further cured through the second curing process.

The liquid crystal display device manufactured by the above-mentioned method according to the present exemplary embodiment may increase an orientation order of the liquid crystal molecules LC. Accordingly, defects in random texture, which are caused when the liquid crystal molecules LC are disordered, may be reduced and an anchor ring energy is increased with respect to the main alignment layer, so that a force of which the liquid crystal molecules LC return to their initial state after being aligned, e.g., a restoration force, is increased. As a result, among a time period during which the liquid crystal molecules LC are aligned by the electric field, e.g., a rising time, and a time period during which the aligned liquid crystal molecules LC return to its initial state, e.g., a falling time, the falling time is reduced, and thus the response speed of the liquid crystal molecules LC becomes fast.

FIG. 5 is a graph showing a transmittance as a function of the applied voltage in the liquid crystal display device according to an exemplary embodiment of the present invention when the concentration of the reactive mesogen is about 1 wt % and the first curing temperature of the reactive mesogen is varied. The transmittance has been represented by a normalized value. In FIG. 5, all other conditions are maintained constant except for the first curing temperature and the applied voltage, a cell gap is about 3.2 micrometers, and the pretilt angle is about 89.5 degrees. The first curing temperature at which the transmittance is measured is about −20° C., about 20° C., and about 60° C. Meanwhile, the liquid crystal display device is set to a normally black mode.

Referring to FIG. 5, as the first curing temperature is decreased, a threshold voltage Vth is lowered. When assuming that black is represented at a point that the transmittance is 0.0 and white is represented at a point that the transmittance is about 1.0, the applied voltage is more shifted at the point that the transmittance is about 0.5 as the first curing temperature is lowered. In the liquid crystal display device operated in the normally black mode, the liquid crystal display device displays the black (at the point that the transmittance is 0.0 in FIG. 5) when no voltage is applied to the liquid crystal layer, but the transmittance is increased as the liquid crystal molecules are driven while the applied voltage is increased. Thus, the liquid crystal display device displays the white (at the point that the transmittance is about 1.0 in FIG. 5). As shown in FIG. 5, however the applied voltage becomes high, which is required to accomplish the transmittance of about 0.5, about 0.8, or about 0.9, as the first curing temperature becomes low. This is because the orientation order is increased and the anchor ring energy of the liquid crystal molecules is increased as the first curing process is performed at a relatively low temperature. When the anchor ring energy is increased, the restoration force of the liquid crystal molecules is increased.

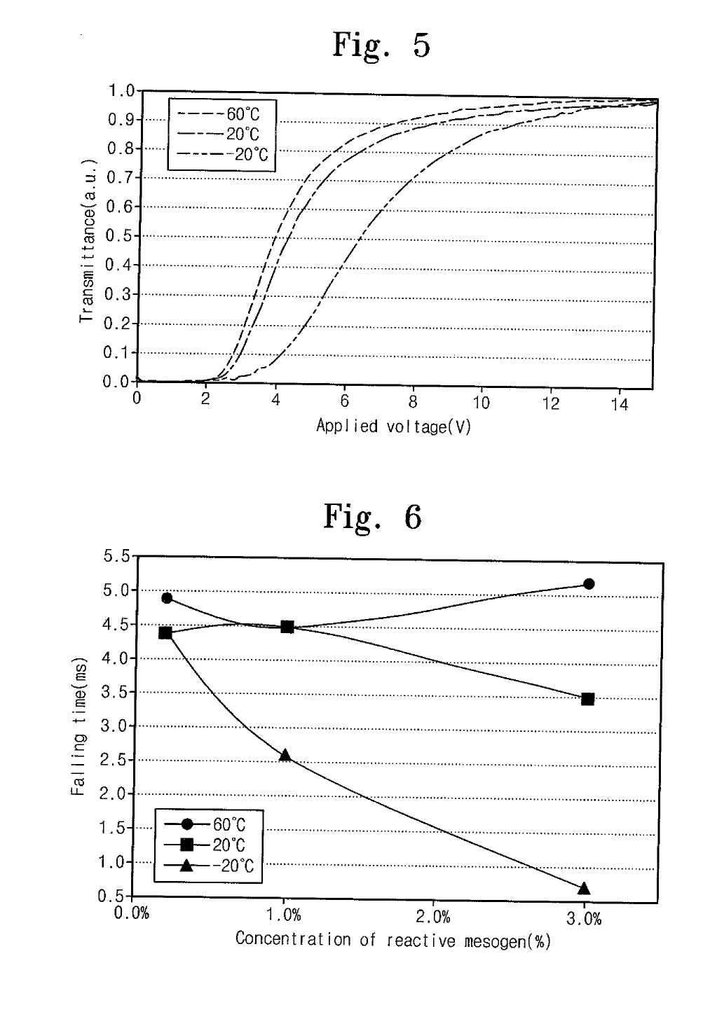

FIG. 6 is a graph showing the falling time according to the concentration and the first curing temperature of the reactive mesogen. In FIG. 6, all other conditions are maintained constant except for the first curing temperature and the concentration of the reactive mesogen RM, and the cell gap is about 3.2 micrometers. The first curing temperature at which the falling time is measured is about −20° C., about 20° C., and about 60° C. The concentration of the reactive mesogen RM is about 0.2 percent by weight, about 1 percent by weight, and about 3 percent by weight relative to the total weight of the liquid crystal composition.

Referring to FIG. 6, when the concentration of the reactive mesogen RM is increased, the falling time is shortened except that the first curing temperature is about 60° C. For example, when the first curing temperature is about −20° C., the falling time is shortest regardless of the concentration of the reactive mesogen RM. In addition, when compared to the falling time measured that the concentration of the reactive mesogen RM is about 3 percent by weight and the first curing temperature is about 20° C., the falling time is shortened by about 80% when the first curing temperature is about −20° C., and the falling time is lengthened by about 50% when the first curing temperature is about 60° C.

For example, when the concentration of the reactive mesogen RM is 0.2 percent by weight relative to the total weight of the liquid crystal composition and the curing temperature of the reactive mesogen RM is equal to or greater than about −20° C. and equal to or smaller than about 20° C., the falling time is reduced by about 10% when compared to that of a conventional liquid crystal display device. In addition, when the concentration of the reactive mesogen RM is about 1.0 percent by weight relative to the total weight of the liquid crystal composition and the curing temperature of the reactive mesogen RM is equal to or greater than about −20° C. and equal to or smaller than about 60° C., the falling time is reduced by about 10% when compared to that of a conventional liquid crystal display device. Further, when the concentration of the reactive mesogen RM is about 3.0 percent by weight relative to the total weight of the liquid crystal composition and the curing temperature of the reactive mesogen RM is equal to or greater than about −20° C. and equal to or smaller than about 50° C., the falling time is reduced by about 10% when compared to that of a conventional liquid crystal display device.

This means that the falling time is shortened as the orientation order is increased and the anchor ring energy is increased when the liquid crystal layer is cured at the relatively low temperature.

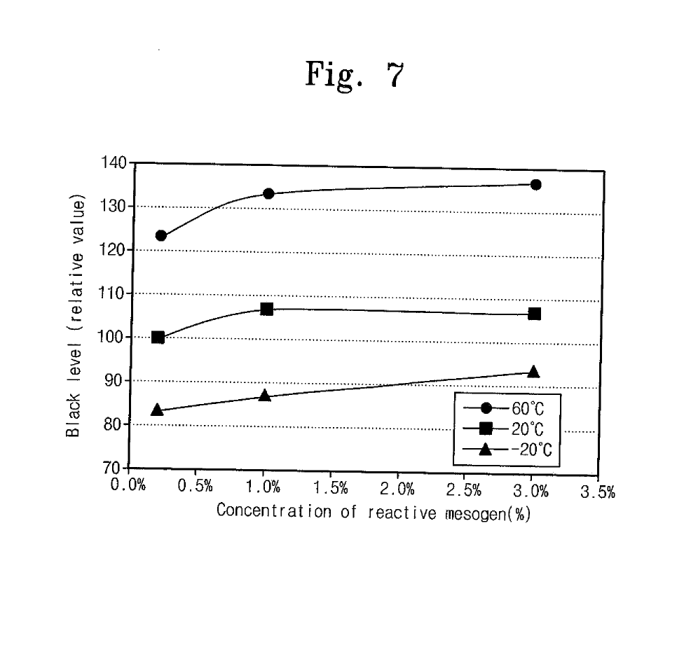

FIG. 7 is a graph showing a relative value of a black level according to the concentration of the reactive mesogen and a first curing temperature of the reactive mesogen. In FIG. 7, as the relative value of the black level becomes small, it indicates the value approximate to the black, and as the relative value of the black level becomes large, it indicates the value approximate to the white. That is, as the relative value of the black level becomes small, it is effective to display the black. In FIG. 7, all other conditions are maintained constant except for the first curing temperature and the concentration of the reactive mesogen RM, and the cell gap is about 3.2 micrometers and the pretilt angle is about 89.5. The first curing temperature at which the falling time is measured is about −20° C., about 20° C., and about 60° C., and the concentration of the reactive mesogen RM is about 0.2 percent by weight, about 1 percent by weight, and about 3 percent by weight relative to the total weight of the liquid crystal composition.

Referring to FIG. 7, as the concentration of the reactive mesogen RM is increased, the value of black level is increased. However, there is a significant difference between the values of the black level according to the first curing temperature. When the first curing temperature is about 60° C., the value of the black level is equal to or greater than about 120, but when the first curing temperature is about 20° C., the value of the black level is equal to or smaller than about 110. For example, when the first curing temperature is about −20° C., the value of the black level is equal to or smaller than about 100. Consequently, when the concentration of the reactive mesogen RM is increased, the value of the black level is increased, but the value of the black level may be sufficiently lowered by reducing the first curing temperature.

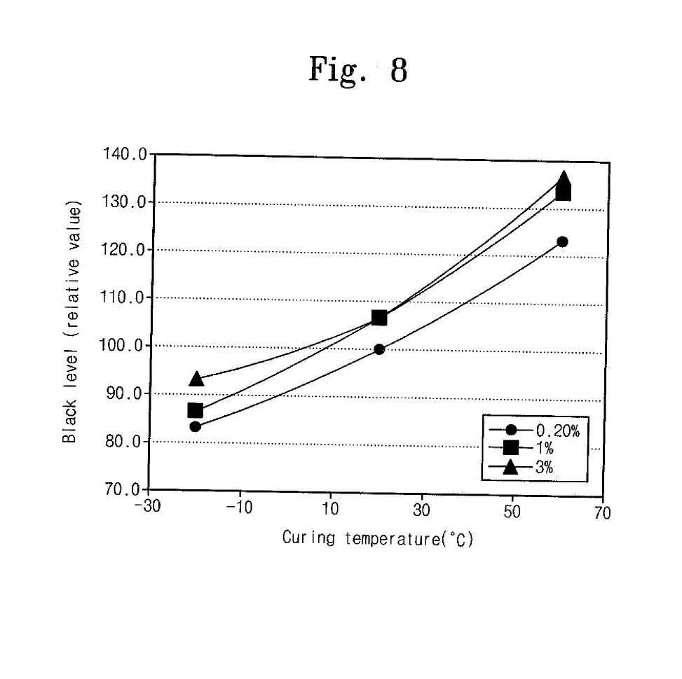

FIG. 8 is a graph showing the relative value of the black level according to the first curing temperature.

Referring to FIG. 8, the first curing temperature, at which the black display is increased by about 5% when compared to that of the conventional liquid crystal display device, is equal to or greater than about −20° C. and equal to or smaller than about 10° C. when the concentration of the reactive mesogen RM is about 0.2 percent by weight, equal to or greater than about −20° C. and equal to or smaller than about 0° C. when the concentration of the reactive mesogen is about 1.0 percent by weight, and equal to or greater than about −20° C. and equal to or smaller than about −10° C. when the concentration of the reactive mesogen RM is about 3M percent by weight. The black level is measured with reference to the black level when the concentration of the reactive mesogen RM is about 0.2 percent by weight relative to the total weight of the liquid crystal composition.

This means that the black display is increased as the orientation order is increased and the random texture is controlled when the liquid crystal layer is cured at the relatively low temperature.

Referring to FIGS. 5 to 8, when the first curing temperature is in a range from about −20° C. to about 20° C., the falling time is shortened and the black display is increased. In this case, the concentration of the reactive mesogen RM exceeds 0 percent by weight and is equal to or smaller than about 30 percent by weight relative to the total weight of the liquid crystal composition. In the case that the concentration of the reactive mesogen RM exceeds about 30 percent by weight, the liquid crystal molecules are difficult to be driven due to the network caused by the polymerization of the reactive mesogen RM. Accordingly, the reactive mesogen RM is included in the amount equal to or smaller than about 30 percent by weight relative to the total weight of the liquid crystal composition.

In addition, as shown in FIGS. 5 to 8, the range of the first curing temperature is varied depending on the amount of the reactive mesogen RM included in the liquid crystal composition. The black display is increased and the falling time is shortened in accordance with the range of the first curing temperature.

In the present exemplary embodiment, when the concentration of the reactive mesogen RM exceeds 0 percent by weight and is equal to or smaller than about 0.5 percent by weight, e.g., about 0.2 percent by weight, relative to the total weight of the liquid crystal composition, the first curing process is performed, for example, at the temperature from about −20° C. to about 20° C. According to an embodiment, the first curing process is performed at the temperature from about −20° C. to about 10° C.

In addition, when the concentration of the reactive mesogen exceeds about 0.5 percent by weight and is equal to or smaller than about 2.0 percent by weight, e.g., about 1.0 percent by weight, relative to the total weight of the liquid crystal composition, the first curing process is performed, for example, at the temperature from about −20° C. to about 60° C. According to an embodiment, the first curing process is performed at the temperature from about −20° C. to about 0° C.

Further, when the concentration of the reactive mesogen exceeds about 2.0 percent by weight and is equal to or smaller than about 5.0 percent by weight, e.g., about 3.0 percent by weight, relative to the total weight of the liquid crystal composition, the first curing process is performed, for example, at the temperature from about −20° C. to about 60° C. According to an embodiment, the first curing process is performed at the temperature from about −20° C. to about 10° C.

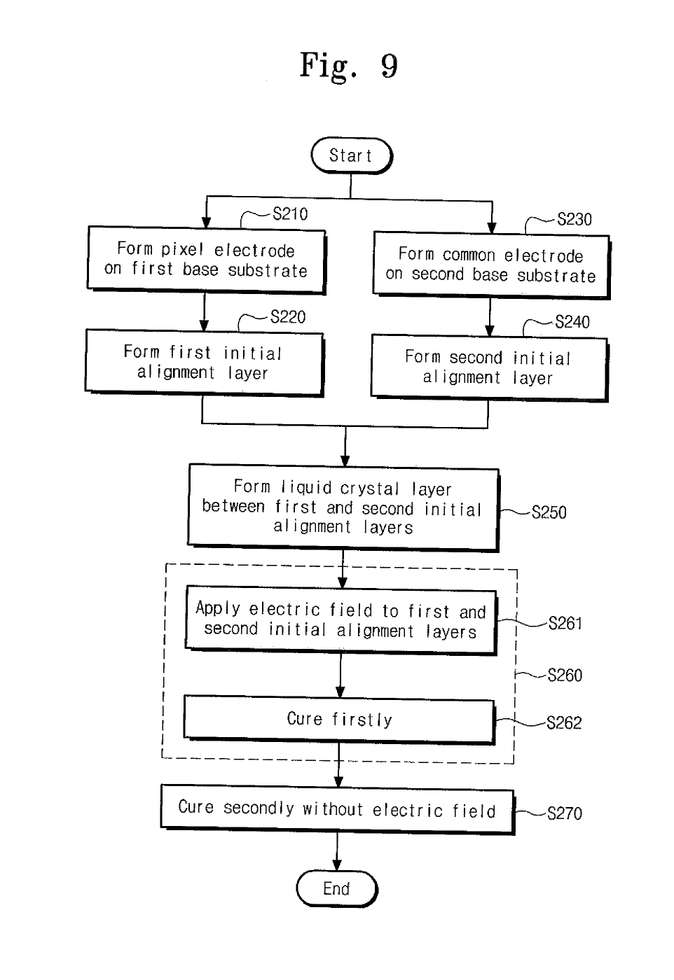

FIG. 9 is a flowchart showing a method of manufacturing the liquid crystal display device according to an exemplary embodiment of the present invention.

In the present exemplary embodiment described with reference to FIGS. 1 to 4B, a super vertical alignment (SVA) mode liquid crystal display device has been shown, in which the liquid crystal layer includes, for example, the reactive mesogen and the first and second reactive mesogen layers are formed by the first and second curing processes. In an exemplary embodiment shown in FIG. 9, however, a surface stabilized vertical alignment (SSVA) mode liquid crystal display device, in which an initial alignment layer includes the reactive mesogen RM and the first and second reactive mesogen layers are formed by the first and second curing processes.

For example, referring to FIG. 9, a pixel electrode is formed on a first base substrate (S210) and a first initial alignment layer is formed on the first base substrate (S220). Separately, a common electrode is formed on a second base substrate (S230) and a second initial alignment layer is formed on the second base substrate (S240).

Then, a liquid crystal layer is disposed between the first initial alignment layer and the second initial alignment layer (S250). Here, for example, the liquid crystal layer does not include the reactive mesogen RM, and the first and second initial alignment layers are polymer layers including the reactive mesogen RM in which polymerization reaction occurs by heat or ultraviolet ray.

The first and second initial alignment layers may include, for example, a polysiloxane. The polysiloxane may have, for example, at least one of a vinyl group and an acryl group, aliphatic alkyl group having a number of carbons in the range of 1 to 12, a cholesteric group, an alicyclic group including an aliphatic alkyl group having a number of carbons in the range of 1 to 10, or an aromatic group including an aliphatic alkyl group having a number of carbons in the range of 1 to 10.

Then, while an electric field is applied to the first and second initial alignment layers (S261), the first reactive mesogen of the first initial alignment layer and the second reactive mesogen of the second initial alignment layer are firstly cured (S262) (S260). Then, the electric field disappears and the first reactive mesogen of the first initial alignment layer and the second reactive mesogen of the second initial alignment layer are secondly cured (S270) so as to form the first reactive mesogen layer and the second reactive mesogen layer.

The polymer including the reactive mesogen RM is, for example, micro-phase separated into a lower layer configured to include a polymer network and an upper layer configured to include the reactive mesogen RM during the first curing process, and thus the first and second reactive mesogen layers are formed.

For example, in the exemplary embodiment described in FIG. 3, the liquid crystal layer LCL includes the reactive mesogen RM, but the main alignment layers ALN1 and ALN2 do not include the reactive mesogen RM. Accordingly, the main alignment layers ALN1 and ALN2 are maintained as they are formed, and the reactive mesogen RM of the liquid crystal layer LCL may be connected to the main alignment layers ALN1 and ALN2 through the polymerization reaction during the first curing process. In the present exemplary embodiment described in FIG. 9, however the liquid crystal layer does not include the reactive mesogen RM and the initial alignment layers include the reactive mesogen RM. Thus, the micro-phase separation occurs in the initial alignment layers during the first curing process, and thus the initial alignment layer is separated into the lower layer and the upper layer formed on the lower layer and including the reactive mesogen RM. The upper layer is changed to the first and second reactive mesogen layers by the first curing process.

Then, as discussed above, the electric field disappears and the first reactive mesogen of the first initial alignment layer and the second reactive mesogen of the second initial alignment layer are secondly cured.

Here, the temperatures of the first and second curing processes may be, for example, the same as those of the first and second curing processes in the exemplary embodiment described in FIG. 3. When the curing temperature is lowered, the black display is increased and the falling time is shortened.

Having described exemplary embodiments of the present invention, it is further noted that it is readily apparent to those of ordinary skill in the art that various modifications may be made without departing from the spirit and scope of the invention which is defined by the metes and bounds of the appended claims.

What is claimed is:

1. A method for forming a display device, comprising:
forming a liquid crystal layer between a first substrate and a second substrate spaced apart from the first substrate, wherein the liquid crystal layer comprises a liquid crystal composition including a reactive mesogen;
applying an electric field to the liquid crystal layer;
firstly curing the liquid crystal layer at a temperature from about −20° C. to about 60° C.; and
secondly curing the liquid crystal layer without applying the electric field,
wherein the liquid crystal composition comprises the reactive mesogen in an amount exceeding 0 percent by weight and equal to or smaller than about 30 percent by weight relative to a total weight of the liquid crystal composition.

2. The method of claim 1, wherein the liquid crystal composition comprises the reactive mesogen in the amount exceeding 0 percent by weight and equal to or smaller than about 0.5 percent by weight relative to the total weight of the liquid crystal composition and wherein the first curing is performed at the temperature from about −20° C. to about 20° C.

3. The method of claim 2, wherein the first curing is performed at the temperature from about −20° C. to about 10° C.

4. The method of claim 3, wherein the liquid crystal composition comprises the reactive mesogen in the amount of about 0.2 percent by weight relative to the total weight of the liquid crystal composition.

5. The method of claim 1, wherein the liquid crystal composition comprises the reactive mesogen in the amount exceeding about 0.5 percent by weight and equal to or smaller than about 2.0 percent by weight relative to the total weight of the liquid crystal composition and wherein the first curing is performed at the temperature from about −20° C. to about 60° C.

6. The method of claim 5, wherein the first curing is performed at the temperature from about −20° C. to about 0° C.

7. The method of claim 6, wherein the liquid crystal composition comprises the reactive mesogen in the amount of about 1.0 percent by weight relative to the total weight of the liquid crystal composition.

8. The method of claim 1, wherein the liquid crystal composition comprises the reactive mesogen in the amount exceeding about 2.0 percent by weight and equal to or smaller than about 5.0 percent by weight relative to the total weight of the liquid crystal composition and wherein the first curing is performed at the temperature from about −20° C. to about 60° C.

9. The method of claim 8, wherein the first curing is performed at the temperature from about −20° C. to about −10° C.

10. The method of claim 9, wherein the liquid crystal composition comprises the reactive mesogen in the amount of about 3.0 percent by weight relative to the total weight of the liquid crystal composition.

11. The method of claim 1, further comprising applying an ultraviolet ray to the liquid crystal layer.

12. The method of claim 11, wherein the applying of the ultraviolet ray is substantially simultaneously performed with the applying of the electric field.

13. The method of claim 1, further comprising forming a main alignment layer on at least one of the first substrate and the second substrate.

14. The method of claim 13, wherein the main alignment layer is aligned by one of a light, ion beam, or rubbing method.

15. The method of claim 1, wherein the second curing is performed using one of a heat or an ultraviolet ray.

16. The method of claim 1, further comprising:
forming a pixel electrode on the first substrate; and
forming a common electrode on the second substrate, wherein the electric field is formed between the pixel electrode and the common electrode.

17. The method of claim 16, wherein the pixel electrode comprises a trunk portion and a plurality of branch portions protruded and extended from the trunk portion.

18. The method of claim 17, wherein the first substrate comprises a plurality of pixel areas each including a plurality of domains and wherein the branch portions are extended in different directions according to the domains.

19. A method for forming a display device, comprising:
forming a pixel electrode on a first base substrate;
forming a first main alignment layer on the first base substrate on which the pixel electrode is formed;
forming a common electrode on a second base substrate disposed opposite to the first base substrate;
forming a second main alignment layer on the second base substrate on which the common electrode is formed;
forming a liquid crystal layer between the first and second main alignment layers, wherein the liquid crystal layer comprises a liquid crystal composition including a reactive mesogen;
applying an electric field to the liquid crystal layer;
firstly curing the reactive mesogen of the liquid crystal layer at a temperature from about −20° C. to about 60° C. while the electric field is being applied to the liquid crystal layer; and
secondly curing the reactive mesogen of the liquid crystal layer without applying the electric field to the liquid crystal layer, thereby forming a first reactive mesogen layer disposed on the first main alignment layer and a second reactive mesogen layer disposed on the second main alignment layer,
wherein the liquid crystal composition comprises the reactive mesogen in an amount exceeding 0 percent by weight and equal to or smaller than about 30 percent by weight relative to a total weight of the liquid crystal composition.

20. The method of claim 19, wherein the reactive mesogen is a compound represented by, the following chemical formula 1:
R₁—P-Q-R₂ Chemical formula 1
wherein each of P and Q individually represents 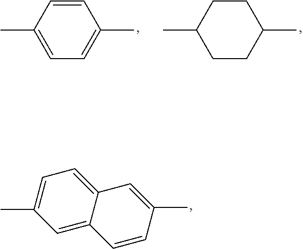
or a single bond except that P and Q are simultaneously single bond. Hydrogen atoms of P and Q are substituted by F, Cl, alkyl group having a number of carbons in the range of 1 to 12, or —OCH₃, and each of R₁ and R₂ individually represents 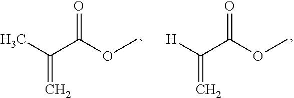
or hydrogen atoms except that R₁ and R₂ are simultaneously single bond.

21. The method of claim 19, wherein the reactive mesogen includes one of an acrylate, methacrylate, an epoxy, oxetane, a vinyl-ether, a styrene, or a thiolene group.

22. The method of claim 19, wherein the firstly curing and the secondly curing processes are performed at the same temperature as each other.

23. The method of claim 19, wherein the firstly curing and the secondly curing processes are performed at a different temperature from each other.

24. A method for forming a display device, comprising:
forming a first initial alignment layer on a first base substrate, wherein the first initial alignment layer is a polymer layer including a first reactive mesogen;
forming a second initial alignment layer on a second base substrate disposed opposite to the first base substrate, wherein the second initial alignment layer includes a second reactive mesogen;
forming a liquid crystal layer between the first initial alignment layer and the second initial alignment layer, wherein the liquid crystal layer comprises a liquid crystal composition which does not include a reactive mesogen;
applying an electric field to the first and second initial alignment layers;
firstly curing the first and second initial alignment layers at a temperature from about −20° C. to about 60° C. while the electric field is being applied to the first and second initial alignment layers; and
secondly curing the first and second initial alignment layers without applying the electric field to the first and second initial alignment layers, thereby forming a first reactive mesogen layer on the first base substrate and a second reactive mesogen layer on the second base substrate.

25. The method of claim 24, wherein the first and second initial alignment layers each include a polysiloxane.

26. The method of claim 25, wherein the polysiloxane has at least one of a vinyl group and an acryl group, an aliphatic alkyl group having a number of carbons in the range of 1 to 12, a cholesteric group, an alicyclic group including an aliphatic alkyl group having a number of carbons in the range of 1 to 10, or an aromatic group including an aliphatic alkyl group having a number of carbons in the range of 1 to 10.
